(19) United States
(12) Patent Application Publication
(10) Pub. No.: US 2020/0413138 A1
(43) Pub. Date: Dec. 31, 2020

(54) Adaptive Media Playback Based on User Behavior

(71) Applicant: BITMOVIN, INC., San Francisco, CA (US)

(72) Inventor: Mario GRAF, Klagenfurt-Viktring (AT)

(73) Assignee: BITMOVIN, INC., San Francisco, CA (US)

(21) Appl. No.: 17/021,994

(22) Filed: Sep. 15, 2020

Related U.S. Application Data
(63) Continuation of application No. PCT/US2019/024920, filed on Mar. 29, 2019.
(60) Provisional application No. 62/653,324, filed on Apr. 5, 2018.

(51) Int. Cl. H04N 21/442; H04N 21/81; H04N 21/2343

(52) U.S. Cl. CPC H04N 21/44218; H04N 21/234363; H04N 21/812

(57) ABSTRACT

Media playback may be controlled or adapted using behavioral player adaptation. The user and the user's physical environment are monitored via sensors. Sensor data representative of relevant user behavior and physical properties of the environment where the user is located is collected, aggregated, and pre-processed to determine the state of parameters of the sensed environment that may be relevant. The pre-processed sensor data is examined to determine the state of user model parameters. Machine learning may be used for the data examination; a neural network is used to learn the key parameters from the pre-processed data that then are used for media playback adaptation and/or control.

### CROSS-REFERENCE TO RELATED APPLICATIONS

This application claims priority to U.S. Provisional Patent Application No. 62/653,324 filed on Apr. 5, 2018, the contents of which are incorporated herein by reference in their entirety.

### BACKGROUND

This disclosure generally relates to streaming and playback of video or other media, and more particularly to the adaptive playback and multimedia player control based on user behavior. In addition to the more traditional televisions and projector-based systems connected to Internet-provider networks at the home, many playback devices today are mobile devices, such as tablets, smartphones, laptops, VR goggles, and the like, which typically include sensors capable of detecting different aspects of user behavior. Traditional television and projector-based systems are at times also enhanced with sensors, either built-in with the same device or as peripheral enhancements connected via other devices, such as gaming consoles, computers, and the like.

For example, cameras, depth sensors, gyroscope-based controllers, and the like, are sometimes integrated via game consoles as playback devices and displayed on televisions or projection screens. State of the art mobile devices similarly come equipped with multiple sensors, such as sensors for light, motion, depth/distance, temperature, biometrics (such as fingerprints, heart rate, and the like), location, orientation, and the like. These mobile devices, capable of playing back multimedia, either locally stored media or streaming from servers or cloud services, may also be enhanced with sensor input from other devices. For example, wearable devices, such as smart watches, fitness bands, or similar sensor-equipped wearables, operate in tandem with player-capable mobile devices.

While sensor technology has been integrated into video game controllers, the use of sensor input to monitor user behavior for controlling or adapting the playback of media has not been significantly leveraged to-date. Some prototype work and research in this area has shown the use of sensors for location detection as an input for controlling media playback. For example, using image or depth sensing camera systems to determine a user's location as a means to control media playback functions, such as for example, stopping or pausing a video playback upon detection of a user leaving the room where the playback is taking place. However, this rudimentary control does not leverage the rich sensor inputs available to detect and infer more nuanced user behavior. Thus, what is needed is a system and method capable of leveraging rich sensor data from user devices to control media playback.

### BRIEF DESCRIPTION OF THE DRAWINGS

The subject matter which is regarded as the invention is particularly pointed out and distinctly claimed in the claims at the conclusion of the specification. The features and advantages of the invention are apparent from the following detailed description taken in conjunction with the accompanying drawings in which:

FIG. 1 is an illustration of a device for playback of content according to embodiments of the disclosure.

FIG. 2 is an illustration of a block diagram for the modules of a sensor-based device for playback of content according to embodiments of the disclosure.

FIG. 3 is an illustration of a behavioral player adaptation workflow according to embodiments of the disclosure.

### SUMMARY

According to embodiments, a method and system for controlling playback of media based on features inferred from sensor data is provided. In embodiments, the system may collect first sensor data representative of a behavior of a user, the behavior indicative of an attention level of the user with respect to a playback of media. The system may also collect second sensor data representative of one or more physical properties of a playback environment where the user is located during the playback of media. The first sensor data and the second sensor data are examined to determine a state of one or more parameters of a user model, the one or more parameters representative of features of interest for controlling the playback of media. For example, the determined state may include one or more of a “not paying attention” state, “paying attention” state, “looking away” state, “left the room” state, “present” state, “awake” state, and “asleep” state. Based on the determined state of the one or more parameters of the user model, the system automatically performs a control function associated with the playback of media. The control function is not a function corresponding to a command received from the user.

In embodiments, a machine learning module is used to examine the sensor data. The machine learning module learns one or more states for the one or more parameters of the user model from the first sensor data, the second sensor data, and user feedback. The user feedback may be received in response to the performing the control function. In embodiments, a mapping between a first state of the one or more parameters of the user model and a first control function may be learned. In some embodiments, the user feedback may be received in response to performing the first control function, and the mapping may be adapted to a second control function based on the user feedback. In some embodiments, if the determined state is “not paying attention” the control function delays advertising from being played during the media playback.

8. In embodiments, a remote server is notified a user attention information regarding the attention level of the user during the playback of media based on the determined state of the one or more parameters of the user model. In these embodiments, the media may correspond to advertising media for which the user is given credit upon playback. In that case, the credit may be based at least in part on the user attention information.

9. In embodiments, the control function may cause a resolution of media being streamed for playback to change based on the one or more parameters of the user model indicating a change in the user behavior. For example, the resolution of the media may be decreased when the change in the user behavior is an increase in distance between a display of the media and the user. As another example, the resolution of the media may be decreased when the change in the user behavior corresponds to a low attention level. As yet another example, the resolution of the media may be increased when the change in the user behavior corresponds to a high attention level.

13. In some embodiments, the one or more parameters of the user model may be reported to a cloud-based analytics server.

### DESCRIPTION OF EMBODIMENTS OF THE INVENTION

The following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments.

The above and other needs are met by the disclosed methods, a non-transitory computer-readable storage medium storing executable code, and systems for streaming and playing back video content.

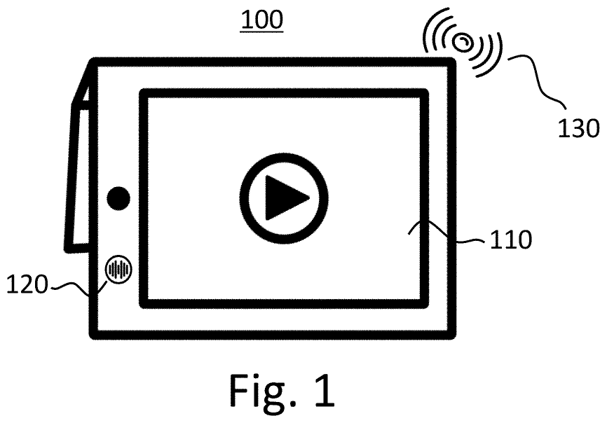

To address the problem identified above, in one embodiment, playback of media is adjusted and adapted based on behavioral information from the viewer. With reference to FIG. 1, in one embodiment, the media stream is played back on a device 100. For example, device 100 may be a mobile phone, smartphone, tablet, laptop or other computer, VR device, or any other device capable of playing back multimedia, for example with a multimedia player 110. Multimedia includes video and/or audio in any form, including streaming or downloaded video, music, computer games, simulations, 3D content, virtual reality or augmented reality presentations and the like. In this embodiment, the playback device 100 includes one or more multimedia players 110 that react depending on user behavior.

In one embodiment, the player device 100 includes one or more sensors 120. For example, sensors, 120 may include accelerometers, gyroscopes, magnetometers, GPS sensors, standard/optical cameras, infrared cameras, light projectors (“TrueDepth” cameras), proximity sensors and ambient light sensors, among others. In an alternative embodiment (not shown) sensors may be located remote from the player device 100 and communicatively coupled to the player device 100 either via wired or wireless connection 130, for example, via Bluetooth, Wi-Fi, USB, or similar connection. In one embodiment, player device 100 receives sensor input from built-in sensors 120 and from remote sensors (not shown).

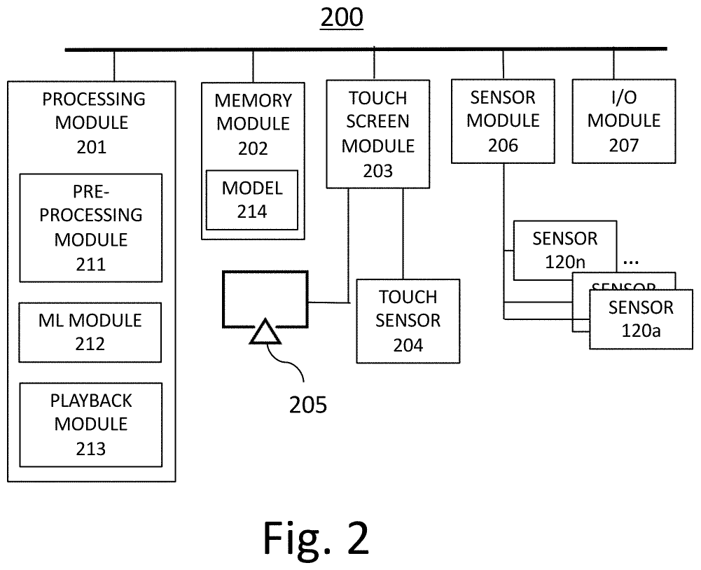

Now referring to FIG. 2, a block diagram of a sensor-based media player controller system 200 according to one embodiment is provided. The system 200 includes a set of modules. In one embodiment, system 200 includes a processing module 201, a memory module 202, a touch screen module 203, a sensor module 206, and an I/O module 207. A different set of modules or additional modules may be present in different embodiments. The system 200 is capable of medial playback on a screen 205 and may receive user input via touch sensor 204. The system includes a plurality of sensors 120a-120n to monitor and track the user and various environmental conditions, such as for example, location, lighting, and the like. The I/O module 207 provides for additional interfaces that may be wired or wirelessly connected to the system 200. For example, in one embodiment, remote sensors (not shown) may provide sensor input to system 200 through I/O module 207, which may include for example, a wireless transceiver, a USB connection, a Wi-Fi transceiver, a cellular transceiver, or the like.

According to one embodiment, processing module 201 includes one or more processors, including for example microprocessors, embedded processors, multimedia processors, graphics processing units, or the like. In one embodiment, processing module 201 implements a set of sub-modules 211-213. In alternative embodiments, the functions performed by the different modules may be distributed among different processing units. For example, some subset of the functionality of processing module 201 may be performed remotely by a server or cloud-bases system. Similarly, memory module 202 may include local and remote components for storage. In one embodiment, pre-processing submodule 211 receives raw sensor data, for example from sensor module 206. After pre-processing, the sensor data is analyzed by machine learning module 212 and used to populate model 214 residing in memory module 202, which, in one embodiment, may include components in a cloud-based storage system. Playback module 213 includes multimedia player control capabilities adapted to use model 214 as part of the multimedia playback adaptation and control. As with other modules, in different embodiments, playback module 213 may be distributed among different processing platforms, including a local device as well as remote server or cloud-based systems.

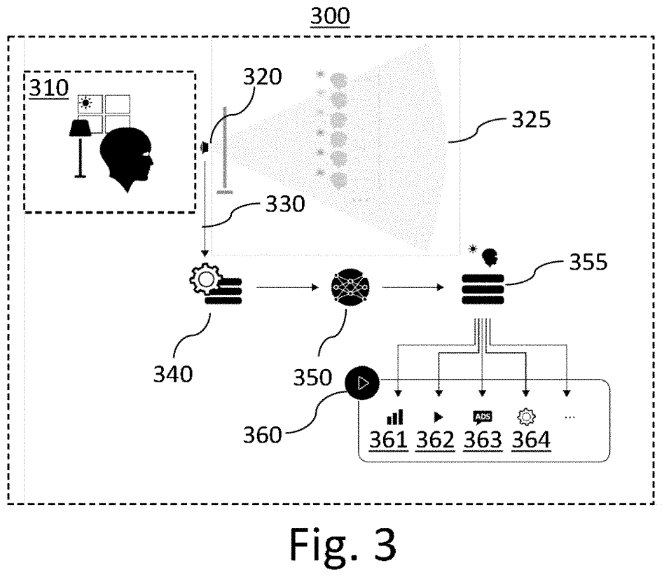

Referring now to FIG. 3, a behavioral player adaptation workflow 300 according to one embodiment is described. The sensed environment 310, including the user and the user's physical environment, is monitored via sensors 320. Sensor raw data 325 is collected 330 representative of relevant user behavior and physical properties of the environment where the user is located. The raw sensor data 325 is aggregated and pre-processed 340 to determine the state of parameters of the sensed environment 310 that may be relevant. The pre-processed sensor data is examined 350, for example applying rules and heuristics to determine the state of user model parameters 355. In one embodiment, machine learning is used for the data examination step 350. For example, a neural network is used to learn the key parameters from the pre-processed data that then are used for media playback adaptation and/or control. In one embodiment, some of the user behaviors that may be tracked include the users face, the user's position and direction relative to the device, the user's facial expressions, and the like.

For example, optical camera and or depth camera raw input data 325 is pre-processed 340 to detect the user's face and within the face, using image recognition, the user's eyes are located. The pre-processed data is then examined 350 to determine, for example, the orientation of the face, e.g., looking at the screen, looking away, etc. Further, the state of the user's eyes is also determined, e.g., are eyes opened or closed. Additional facial state parameters may be used. For example, by analyzing the shape of the mouth, eyes, and other face characteristics, the machine learning module may determine an emotional state of the user, e.g., is the user smiling or not, is the user sad or not, is the user intrigued or not. Additional or different emotional states may be deduced from the facial recognition sensor data. A machine learning algorithm can be trained to recognize facial expressions and corresponding implied emotional states. Additional pre-processed sensor data can include other environmental features, such as light, location, and the like. The machine learning module can further determine, for example, if the user puts the phone away and is not looking/paying attention anymore.

In one embodiment, the machine learning module adapts over time from feedback learned from the user. Feedback can include active feedback, such as for example instructions via a natural language interface to the system to indicate that the adaptation or playback function taken by the system is not appropriate. Alternatively, the system can observe the user's response to an adaptation or change in playback from the system as passive feedback. For example, if the playback was paused due to the system's observations, e.g., “user looking away,” and the user resumes playback while still looking away, the machine learning algorithm will learn from other sensed parameters in the environment that in some instances, “looking away” does not provide sufficient confidence to cause the system to pause playback. The user could stop looking at the screen for several reasons, so it would be necessary for the machine learning module to consider other sensed parameters to infer the correct player behavior from sensor data collected. The machine learning module then learns from other factors, such as time looking away, location of the user within the home (e.g., living room, kitchen, etc.), when the user is interrupted by something which needs his full attention, such as someone ringing the doorbell, and for which the system would pause, or after sufficient time, stop playback. The machine learning module would also learn other set of parameters states that indicate that the user is not looking at the screen but is still interested in the played multimedia, such as for example if a user is cooking, looking at the stove but still paying attention to instructions in a recipe video. In this instance the user may want to continue listening to the audio while not looking at the screen. The machine learning module would learn that it should not stop playback in this scenario, which may be indicated for example from learning in prior instances based on user location, time of day, location of the playback device (e.g., connected to kitchen Bluetooth speaker), and the like. The system however could take other adaptive playback actions, such as for example, it could reduce the streamed video resolution or fully turn off video streaming to save bandwidth.

The output of the data examination step 350 used to populate or update model parameters 355 representing the various features of interest for adapting or controlling media playback. With the gathered model information, the multimedia player can adapt automatically based on the detected user behavior, instead of in response to commands issued by the user.

For example, in one embodiment, playback functions 360 are automatically adapted or controlled, based at least in part, on user model parameters 355. For example, in one embodiment, playback control functions 362 are adapted based on user model parameters 355. For example, the playing back of multimedia is paused when the user model indicates a state of “not paying attention.” This state of the model is set, for example, when the sensor data indicates the user's face is not looking at the screen for a pre-determined period of time, for example, due to eyes being closed, face looking in a direction away from the screen, or the like. Further, if the model indicates that the user state is “asleep,” the player will stop playback and store the location in the presentation when the user was determined to have closed his or her eyes so as to resume playback from there after the user state changes to “awake.” Additional or different playback control functions may be adapted or controlled based on user model parameters in other embodiments.

According to another aspect of one embodiment, advertising functions 363 are automatically adapted based on user model parameters 355. For example, in one embodiment, when the user model state indicates that the user is “not paying attention,” advertising is not displayed to the user. The ad schedule is modified to delay the ad until the user model state changes to “paying attention” or until the “paying attention” state is maintained for a period of time. Further, for embodiments that may credit users for watching advertisements, e.g., incentive-based models, the user incentive or credit may be adjusted based on the user model parameters 355. For example, if a user is not looking at the advertising, the advertising may be paused, the user may not be given credit for it, or the like. When the user model state shows “paying attention” the user may receive full credit. If the user model determines that the user is paying partial attentions, e.g., eyes look away from screen with some frequency during the ad playback, the user may receive some reduced credit. Additional or different advertising playback functions may be adapted or controlled based on user model parameters in other embodiments.

According to yet another aspect of one embodiment, adaptive streaming functions 364 may be further adapted based on user model parameters 355. For example, the streaming resolution may be reduced when the user model state indicates that the distance from the screen to the user, given the screen size, does not allow for the user to perceive a higher resolution of the streamed media. Similarly, if the user model indicates that the user is has stepped away or is not paying attention, the streaming resolution may be reduced and then increased when the user returns or the state changes to “paying attention.” Additional or different adaptive streaming functions may be adapted or controlled based on user model parameters in other embodiments.

According to another aspect of one embodiment, playback analytics functions 361 may be adapted or controlled based on user model parameters 355. For example, the model parameters about the tracked user may be reported to a cloud-based analytics backend. In addition, the model data can be further analyzed, for example using machine learning, to calculate sophisticated metrics like if the user likes a particular video or which parts of a given video the user likes. This improves over existing approaches based on more simplistic monitoring of user's playback functions and interest, such as tracking videos played, or time spent watching, or the like. By augmenting the data set with additional model parameters based on rich sensor data, e.g. face recognition for emotional states, the accuracy of learning of the user's likes and dislikes is increased.

According to various alternative embodiments, the model parameters 355 may include parameters initially set in the system from inception as well as parameters and states learned via machine learning from training or observations. For example, the user model may include parameters that correspond to a “not paying attention” state, “paying attention” state, “looking away” state, “left the room” state, “present” state, “awake” state, “asleep” state, and the like. These various states provide a combination of model states that may cause corresponding adaptation or changes in the different playback functions 360 discussed above. In addition, the machine learning module may learn additional model states, e.g., “cooking” state, and corresponding adaption or changes to the playback function behavior based on changes in the learned user “intent.” Thus, for example, while initially the system would cause the playback control functions 362 to pause video playback due to a “not paying attention” state caused by the user not looking at the screen for a period of time, after some use, the machine learning module creates a “cooking” state that is also triggered by the user not looking at the screen for a period of time, but also includes a sensed location, the kitchen, and a time of day, between 11 am and 1 pm. For this learned user model state, the corresponding adaptation may be for example to keep playing but reduce the streaming video quality in the adaptive streaming functions 364. The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

1. A method for controlling playback of media based on features inferred from sensor data, the method comprising:
collecting first sensor data representative of a behavior of a user, the behavior indicative of an attention level of the user with respect to a playback of media;
collecting second sensor data representative of one or more physical properties of a playback environment where the user is located during the playback of media;
examining the first sensor data and the second sensor data to determine a state of one or more parameters of a user model, the one or more parameters representative of features of interest for controlling the playback of media; and
based on the determined state of the one or more parameters of the user model, automatically performing a control function associated with the playback of media,
wherein the control function is not a function corresponding to a command received from the user.

2. The method of claim 1, wherein the examining step comprises a machine learning module that learns one or more states for the one or more parameters of the user model from the first sensor data, the second sensor data, and user feedback.

3. The method of claim 1, wherein the determined state includes one or more of a “not paying attention” state, “paying attention” state, “looking away” state, “left the room” state, “present” state, “awake” state, and “asleep” state.

4. The method of claim 2, further comprising receiving the user feedback in response to the performing the control function.

5. The method of claim 2, further comprising learning a mapping between a first state of the one or more parameters of the user model and a first control function.

6. The method of claim 5, further comprising receiving the user feedback in response to performing the first control function, and adapting the mapping to a second control function based on the user feedback.

7. The method of claim 3, wherein if the determined state is “not paying attention” the control function delays advertising from being played during the media playback.

8. The method of claim 1, further comprising based on the determined state of the one or more parameters of the user model, notifying a remote server a user attention information regarding the attention level of the user during the playback of media, wherein the media corresponds to advertising media for which the user is given credit upon playback and wherein the credit is based at least in part on the user attention information.

9. The method of claim 1, wherein the control function causes a resolution of media being streamed for playback to change based on the one or more parameters of the user model indicating a change in the user behavior.

10. The method of claim 9, wherein the resolution of the media is decreased when the change in the user behavior is an increase in distance between a display of the media and the user.

11. The method of claim 9, wherein the resolution of the media is decreased when the change in the user behavior corresponds to a low attention level.

12. The method of claim 9, wherein the resolution of the media is increased when the change in the user behavior corresponds to a high attention level.

13. The method of claim 1, further comprising reporting the one or more parameters of the user model to a cloud-based analytics server.

14. A system for controlling playback of media based on features inferred from sensor data, the system comprising:
means for collecting first sensor data representative of a behavior of a user, the behavior indicative of an attention level of the user with respect to a playback of media;
means for collecting second sensor data representative of one or more physical properties of a playback environment where the user is located during the playback of media;
means for examining the first sensor data and the second sensor data to determine a state of one or more parameters of a user model, the one or more parameters representative of features of interest for controlling the playback of media; and
means for automatically performing a control function associated with the playback of media based on the determined state of the one or more parameters of the user model;
wherein the control function is not a function corresponding to a command received from the user.

15. The system of claim 14, wherein the means for examining comprises a machine learning module that learns one or more states for the one or more parameters of the user model from the first sensor data, the second sensor data, and user feedback.

16. The system of claim 15, further comprising means for receiving the user feedback in response to the performing the control function.

17. The system of claim 15, wherein the machine learning module further comprises means for learning a mapping between a first state of the one or more parameters of the user model and a first control function.

18. The system of claim 17, further comprising means for receiving the user feedback in response to performing the first control function, and wherein the machine learning module further comprises means for adapting the mapping to a second control function based on the user feedback.

19. The system of claim 14, further comprising means for notifying a remote server a user attention information regarding the attention level of the user during the playback of media based on the determined state of the one or more parameters of the user model, wherein the media corresponds to advertising media for which the user is given credit upon playback and wherein the credit is based at least in part on the user attention information.

20. The system of claim 14, wherein the control function causes a resolution of media being streamed for playback to change based on the one or more parameters of the user model indicating a change in the user behavior.
